(19) United States
(12) Patent Application Publication
(10) Pub. No.: US 2024/0241385 A1
(43) Pub. Date: Jul. 18, 2024

(54) MECHANISM TO ADJUST INTER-AXIAL LENS DISTANCE IN A VR/AR HEADSET

(71) Applicant: Meta Platforms Technologies, LLC, Menlo Park, CA (US)

(72) Inventors: Timothy Pier, Shoreline, WA (US); Daniel Ju, Seattle, WA (US); Robert Coleman Skelton, Woodinville, WA (US); Aric A Fitz-Coy, Seattle, WA (US); Thomas Christopher Frey, Seattle, WA (US); Jonathan Beardsley, Seattle, WA (US); Jiang Ai, Issaquah, WA (US); Kellen Hoo Kerng Chow, Woodinville, WA (US)

(21) Appl. No.: 18/154,762

(22) Filed: Jan. 13, 2023

(51) Int. Cl. G02B 27/01; G02B 7/02; G02B 27/00

(52) U.S. Cl. CPC G02B 27/0176; G02B 7/023; G02B 27/0093; G02B 27/0172; G02B 2027/0159

(57) ABSTRACT

A linear actuation mechanism includes a first threaded rod rotatably fixed on a frame, an actuator mechanically coupled to the first threaded rod and configured to cause a rotation thereof, a first nut threaded onto the first threaded rod and attached to a first eyecup configured to hold a first optical element for a headset display, and a rail on the frame configured to support the first eyecup as it moves with the first nut. A headset including a display and two eyepieces supported by at least the first eyecup and the above linear actuation mechanism, and a method for using the linear actuation mechanism to adjust an inter-axial distance between the eyepieces are also provided.

### BACKGROUND

### Field

The present disclosure is generally related to mechanisms to adjust the inter-axial lens distance (IAD) in a virtual reality/augmented reality (VR/AR) headset. More specifically, the present disclosure includes robust and simple mechanisms for adjusting the position of the lenses in VR/AR displays that can withstand fall shock and provide a smooth and precise adjustment.

### Related Art

Mechanisms to adjust inter-axial distance between the main eyepieces in an AR/VR headset tend to be complex and delicate. This results in a low shock resistance threshold, which means that users have to constantly re-adjust the positioning of the eyepieces due to misalignment or backlash after an impact or shock.

### SUMMARY

In a first embodiment, a linear actuation mechanism includes a first threaded rod rotatably fixed on a frame, an actuator mechanically coupled to the first threaded rod and configured to cause a rotation thereof, a first nut threaded onto the first threaded rod and attached to a first eyecup configured to hold a first optical element for a headset display, and a rail on the frame configured to support the first eyecup as it moves with the first nut.

In a second embodiment, a headset includes a frame, supporting: a display to provide a virtual image generated in an immersive reality application, two optical elements to provide the virtual image to a headset user, and a linear actuation mechanism configured to adjust an inter-axial distance between the two optical elements. The linear actuation mechanism includes an actuator coupled to a mechanical element and configured to cause a motion thereof, a first eyecup configured to support one of the optical elements, the first eyecup coupled to the mechanical element to move in a first direction by a selected distance upon an actuation of the mechanical element, and a second eyecup configured to support another of the optical elements, the second eyecup coupled to the mechanical element to move in a second direction by the selected distance upon the actuation of the mechanical element, wherein the second direction is opposite to the first direction.

In a third embodiment, a method to adjust an inter-axial distance between two eyepieces in a headset, includes identifying a mismatch between an inter-pupil distance of a headset user and the inter-axial distance between the eyepieces, actuating an adjusting mechanism to change the inter-axial distance and to reduce the mismatch between the inter-pupil distance of the headset user and the inter-axial distance between the eyepieces, and storing a configuration of the eyepieces in the headset associated with the inter-axial distance between the eyepieces associated with the headset user.

These and other embodiments will be clear to one of ordinary skill in the art, in view of the following.

### BRIEF DESCRIPTION OF THE FIGURES

FIG. 1 illustrates a headset including a mechanism to adjust IAD between eyepieces, according to some embodiments.

FIGS. 2A-2G illustrate threaded rod mechanisms to adjust IAD in VR/AR headsets, according to some embodiments.

FIGS. 3A-3C illustrate vertical actuators in a mechanism to adjust IAD in VR/AR headsets, according to some embodiments.

FIGS. 4A-4F illustrate a lever system in mechanisms to adjust IAD in VR/AR headsets, according to some embodiments.

FIG. 5 illustrates a disengaging gear in a mechanism to adjust IAD in VR/AR headsets, according to some embodiments.

FIG. 6 illustrates a nematic mechanism to adjust IAD in VR/AR headsets, according to some embodiments.

FIG. 7 is a flow chart illustrating steps in a method for adjusting an inter-axial distance between the eyepieces of a VR/AR headset, according to some embodiments.

In the figures, elements having the same or similar reference numerals are associated with same or similar attributes and features, unless explicitly mentioned otherwise.

### DETAILED DESCRIPTION

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure.

### General Overview

IAD mechanisms for VR/AR headsets have been susceptible to drop tests and have predominantly used a rack and pinion gear system in some way to transfer opposite and opposing motion. However, these approaches are typically complex and delicate, leading to misalignments and necessary readjustments, and often fall short of the desired precision and accuracy to adapt to a user physiognomy.

To resolve the above problem, embodiments as disclosed herein achieve precise opposing motion of the two eyepieces in a VR/AR headset by using a single moving element with multiple hinge points and rails to ensure a linear motion and rugged framework. In addition, some embodiments are capable of being implemented on existing IAD adjustment systems for VR/AR headsets to solve drop test problems. Some embodiments may implement mechanisms as disclosed herein to any component that uses opposing motion of two components with high impact/drop resistance.

In embodiments as disclosed herein, an adjustment range for IAD may vary from about 58 mm to about 72 mm. It is desirable also that the alignment mechanism can sustain at least a 1 m tall drop, and an impact force of up to ten Newton (10 N) or more. It is expected that at least 1200 cycles of operation can occur with no noticeable degradation.

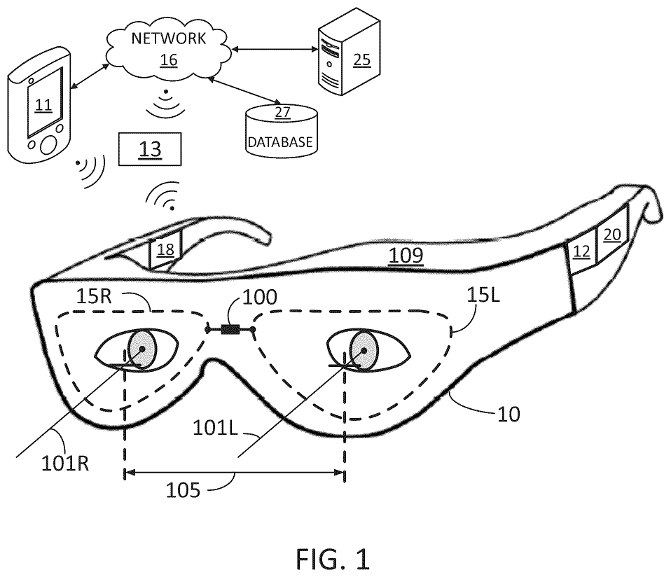

FIG. 1 illustrates a headset 10 including a mechanism to adjust IAD between eyepieces, according to some embodiments. Headset 10 includes a frame 109 and left and right eyepieces 15L and 105R (hereinafter, collectively referred to as “eyepieces 15”). In some embodiments, headset 10 may include a processor circuit 12 and a memory circuit 20. Memory circuit 20 may store instructions which, when executed by processor circuit 12, cause headset 10 to execute one or more steps in methods as disclosed herein. In addition, headset 10 may include a communications module 18. Communications module 18 may include radio-frequency software and hardware configured to wirelessly communicate processor 12 and memory 20 with an external network 16, a remote server 25, a database 27, or a mobile device 11 handled by the user of headset 10. Headset 10, mobile device 11, server 25, and database 27 may exchange commands, instructions, and data, via a dataset 13, through network 16. Accordingly, communications module 18 may include radio antennas, transceivers, and sensors, and also digital processing circuits for signal processing according to any one of multiple wireless protocols such as Wi-Fi, Bluetooth, Near field contact (NFC), and the like. In addition, communications module 18 may also communicate with other input tools and accessories cooperating with headset 10 (e.g., handle sticks, joysticks, mouse, wireless pointers, and the like). Network 16 may include, for example, any one or more of a local area network (LAN), a wide area network (WAN), the Internet, and the like. Further, the network can include, but is not limited to, any one or more of the following network topologies, including a bus network, a star network, a ring network, a mesh network, a star-bus network, tree or hierarchical network, and the like.

Eyepieces 15 include at least one optical element or lens having an optical axis 101R (for eyepiece 15R) or 101L (for eyepiece 15L), that includes the geometric center of the optical element (hereinafter, collectively referred to as “optical axes 101”). Typically, optical axes 101 are parallel, and separated by an inter-axial distance (IAD) 105. For VR/AR headset 10, it is desirable that the pupils of the user be aligned with optical axes 101 (when the user looks straight ahead at “infinity”), and that IAD 105 be approximately similar to the inter-pupil distance (IPD) for the user. Because of the high variability of IPD from person to person, IAD 105 may be adjusted for each user with a mechanism 100. It is desirable that mechanism 100 be precise (fine tuning), reliable, and rugged, to avoid constant readjustment by the user.

Different embodiments and aspects of mechanism 100 will be illustrated in the following figures.

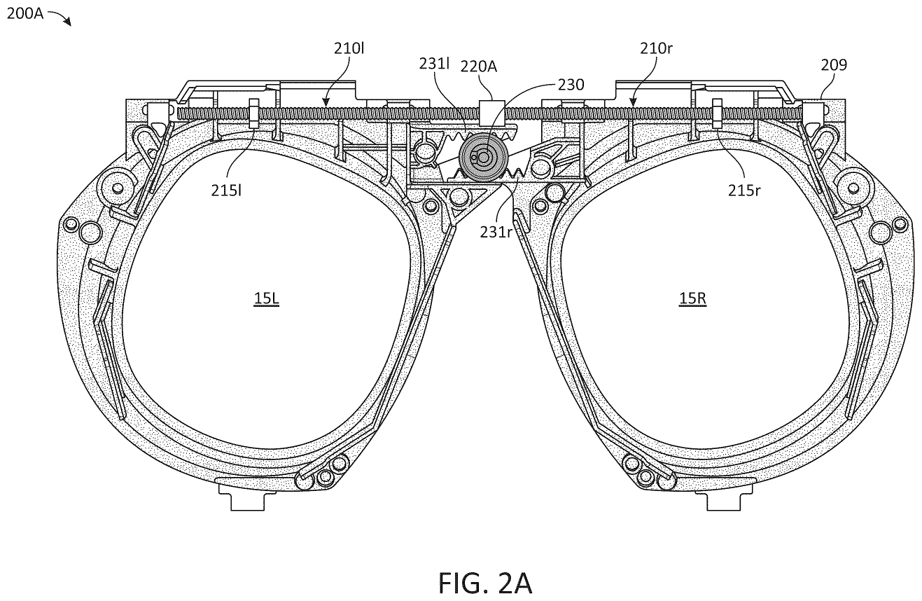

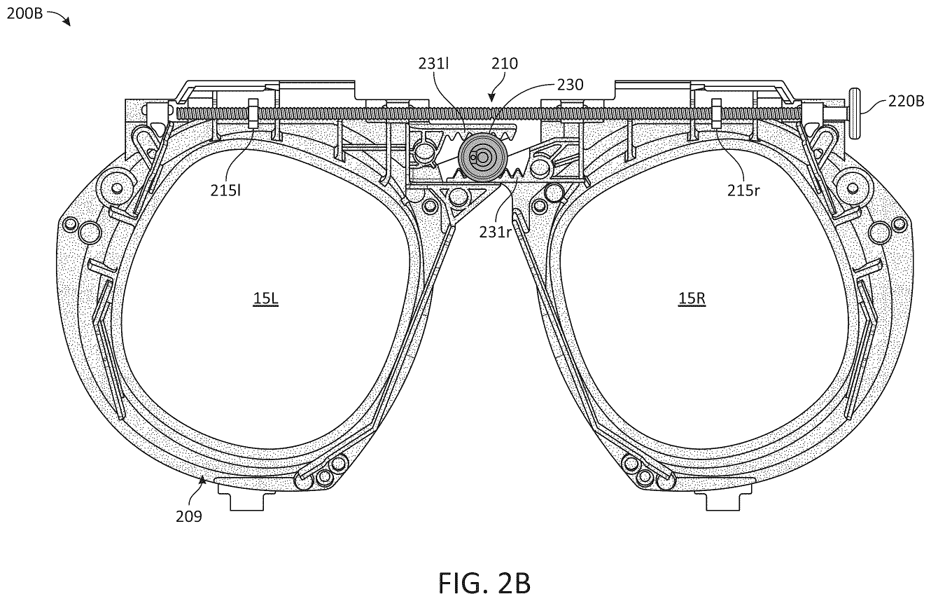

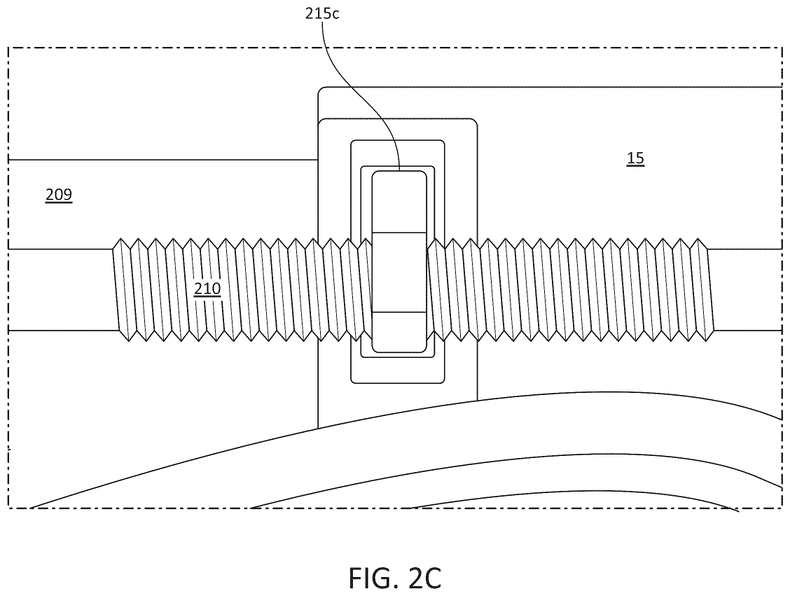

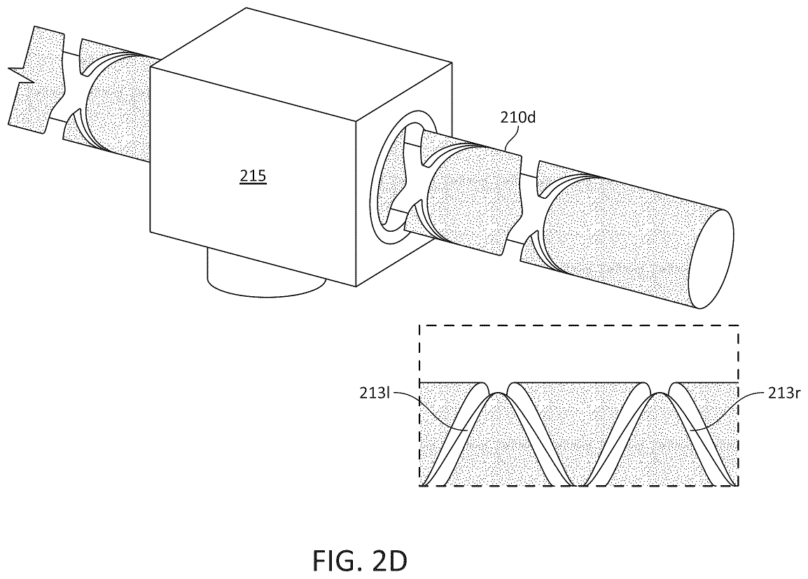

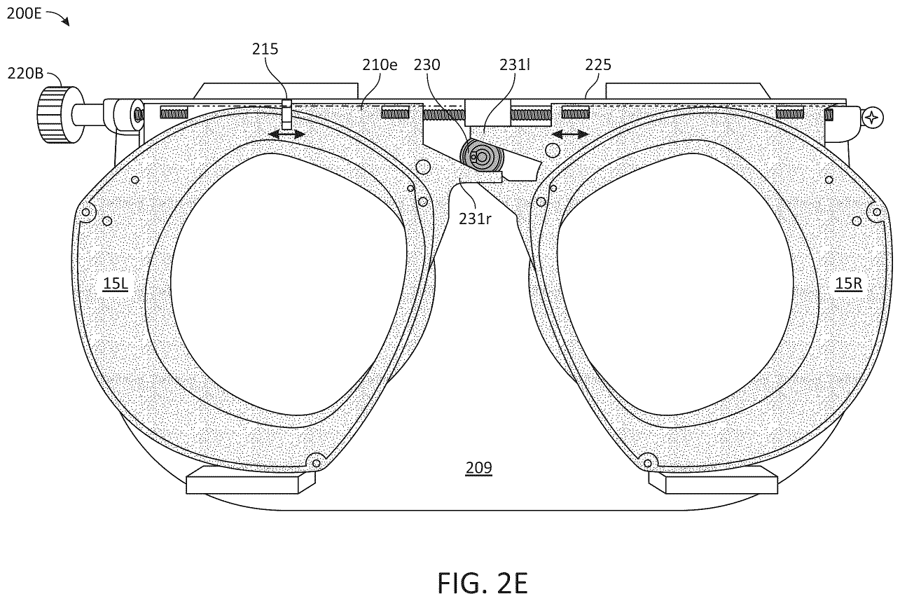

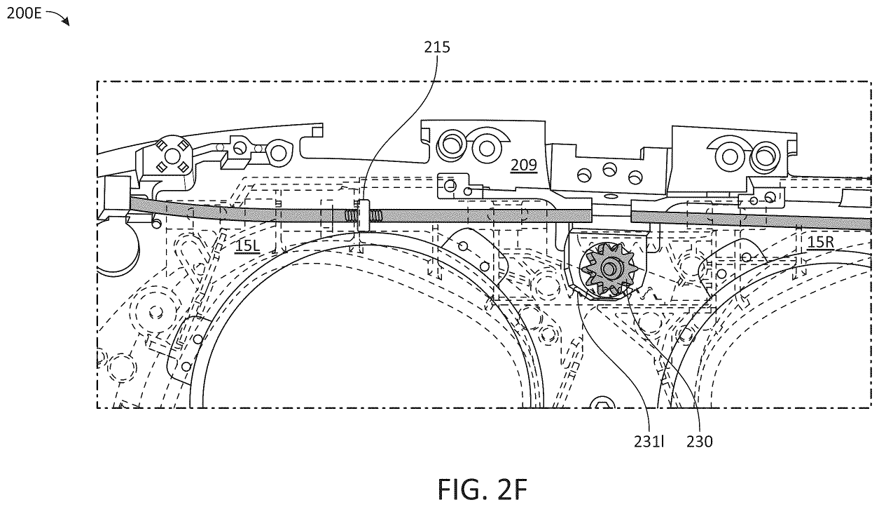

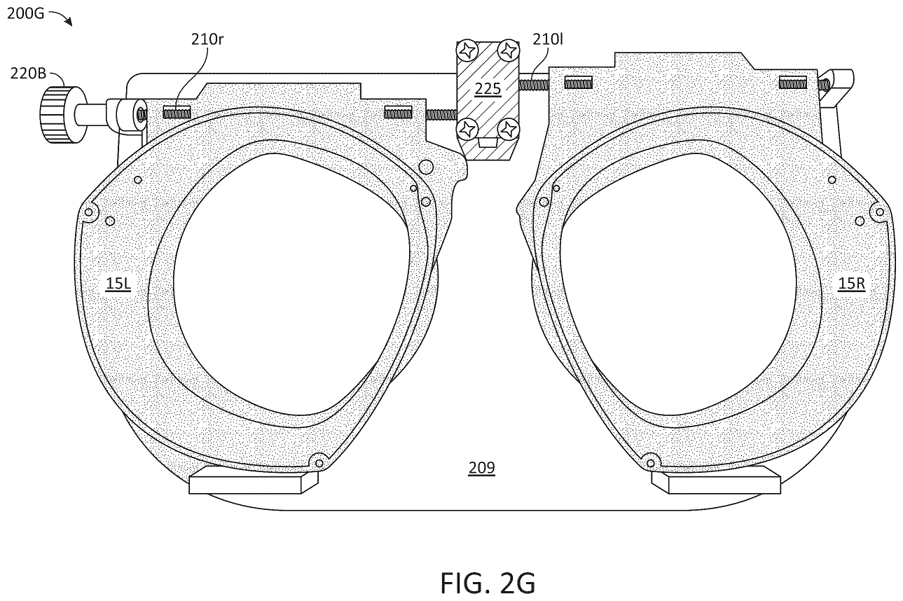

FIGS. 2A-2G illustrate threaded rod mechanisms 200A, 200B, 200E, and 200G (hereinafter, collectively referred to as “mechanisms 200”) to adjust IAD in VR/AR headsets, according to some embodiments. Threaded rod mechanisms 200 may include one or two threaded rods 210l (left), 210r (right), 210d, 210, and 210e (hereinafter, collectively referred to as “threaded rods 210”). Threaded rods 210 are rotated via actuators 220A and 220B (hereinafter, collectively referred to as “actuators 220”). Actuators 220 may include an electric motor, or a manually actuated knob that the user can access. Each of the eyepieces include eyecups 15L (left eyepiece) and 15R (right eyepiece), hereinafter, collectively referred to as “eyecups 15.” Threaded rods 210, actuators 220, and eyecups 15 are mounted on a frame 209. Frame 209 may be built from materials that can sustain a wide thermal range. Materials for frame 209 and eyecups 15 are selected to match the rest of the housing for the VR/AR headset, including glass-filled resins for improved stiffness and reduced shrinkage during molding. Threaded rods 210 may be made of steel, or any other material with appropriate stiffness.

Some embodiments include a central pinion 230 that engages eyecups 15 via rack prongs 231l (left) and 231r (right) (hereinafter, collectively referred to as “rack prongs 231”) in opposite sides, such that as the pinion rotates, eyecups 15 move equally in opposite directions. Upon rotation, threaded rods 210 move one or two nuts 215l (left,) 215r (right), 215c, or 215 (hereinafter, collectively referred to as “nuts 215”), which are attached to eyecups 15, thus moving eyecups 15 towards or away from each other, as desired.

Mechanisms 200A and 200B include threaded rods 210l and 210r which may be a single shaft having opposite threads on each half, being moved by a single electric motor in the middle (actuator 220A), or a manually activated knob (actuator 220B). Pinion 230 and rack prongs 231 may be optional, and in some embodiments they are used for having an accurate register of the position and displacement of eyecups 15.

FIG. 2C illustrates a close-up view of a nut 215c coupled to threaded rod 210. Nut 215c is fixed to an eyecup 15. Threaded rod 210 is fixed to frame 209. As threaded rod 210 rotates, nut 215c moves eyecup 15 relative to frame 209.

FIG. 2D illustrates a close-up view of a nut 215 engaging a double-threaded rod 210d. Double-threaded rod 210d includes a left-hand thread 213l and a right-hand thread 213r. Accordingly, a single shaft may be used, with an actuator rotating in one direction to provide opposite motion of eyecups 15.

Mechanism 200E uses only one threaded rod (210e for eyecup 15L), and a flat shaft or rail 225. As actuator 220B rotates threaded rod 210e, nut 215 moves eyecup 15L. Rack prong 231l pushes pinion 230, which then moves eyecup 15R on rail 225. The use of a single threaded rod 205e for a right eyecup 15R is identical, and the choice is a design consideration that depends on specific applications and device configuration.

Mechanism 200E allows more real estate for other components within a VR/AR headset and allows actuator 220B to be placed along the horizontal direction, rather than vertical. In some embodiments, rod 210e and rail 225 may be part of a single piece that is threaded in the first half portion (e.g., to the left).

FIG. 2F illustrates a freeze frame of a simulated shock on mechanism 200E, as disclosed herein. Nut 215 and rack prong 231l provide two fixed points that dampen the deformation and shock propagating to the right side of mechanism 200E.

Mechanism 200G includes a gear box 225 that reverses the rotation of threaded rod 210l to actuate threaded rod 210r. Accordingly, eyecups 15 move in opposite directions upon activation of actuator 220B. Mechanism 200G enables the use of two right-handed (or left-handed) threaded rods 210.

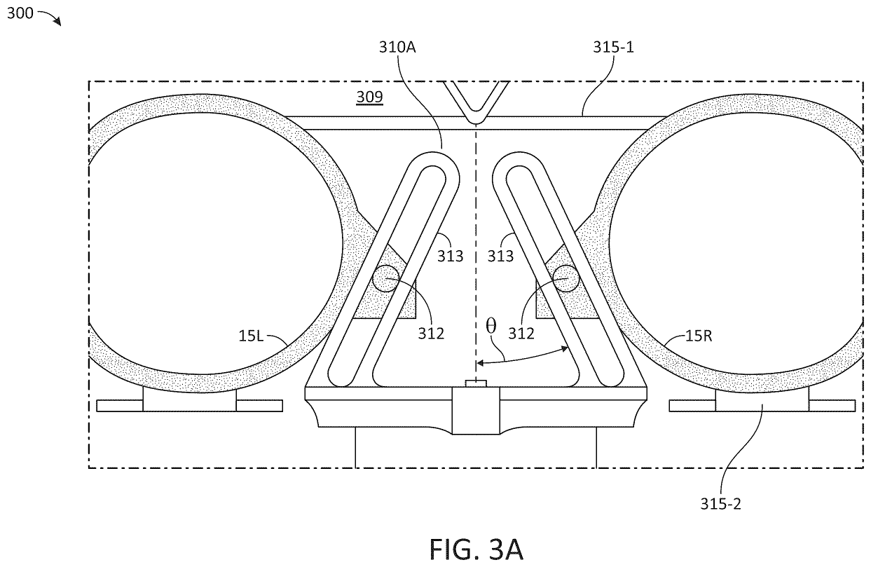

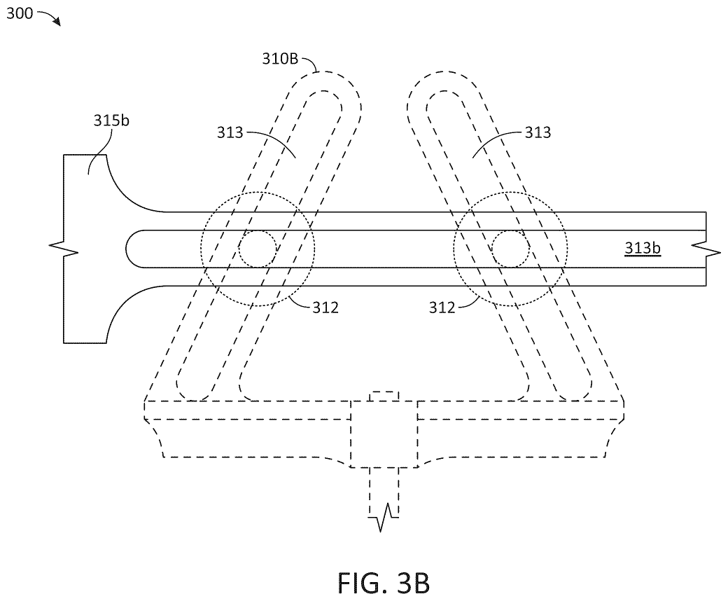

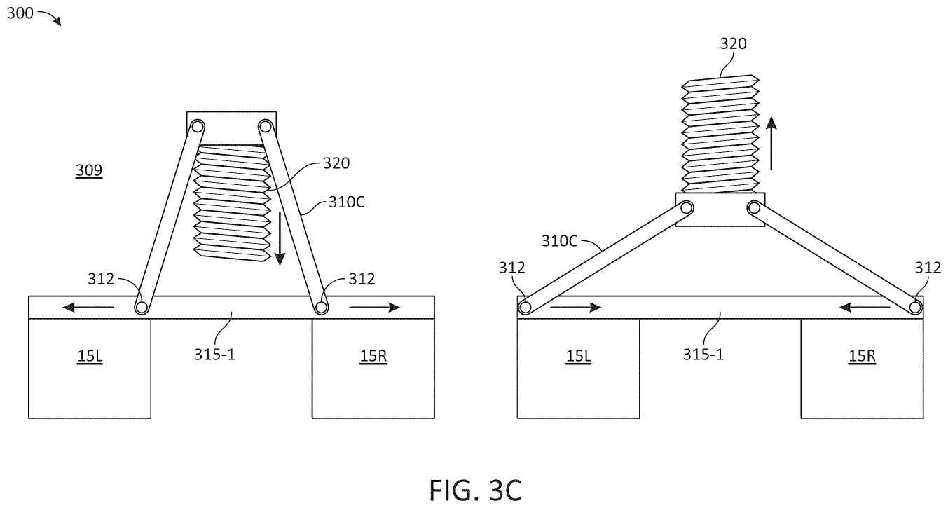

FIGS. 3A-3C illustrate vertical sliders 310A, 310B, and 310C (hereinafter, collectively referred to as “sliders 310”) in a mechanism 300 to adjust IAD in VR/AR headsets, according to some embodiments. The lateral motion of eyecups 15R and 15L (e.g., “eyecups 15”) is guided by rails 315-1 (top) and 315-2 (bottom), hereinafter, collectively referred to as “rails 315.” As sliders 310 move vertically up and down, eyecups 15 move towards or apart, respectively from each other, as pins 312 slide through slots 313. A headset frame 309 is shown as a background. Vertical sliders 310 may be better suited to contain or limit a drop shock because the motion of the adjustment mechanism (vertical) is in a different direction as the motion of eyecups 15 (horizontal).

Slider 310A moves pins 312, which directly displace eyecups 15. Slider 310B moves pins 312, which pass through slots 313 and also a slot 313b for a rail 315b.

An actuator 320 pushes up and down vertical slider 310C, moving eyecups 15 on rail 315-1, accordingly. Actuator 320 may be a screw or a threaded rod fixed on frame 309 that is rotated either manually or via a motor.

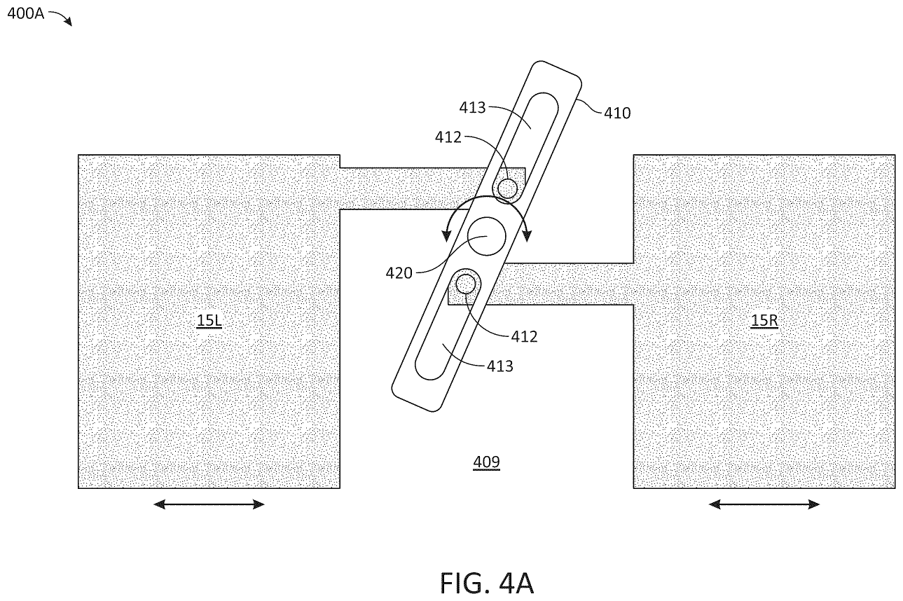

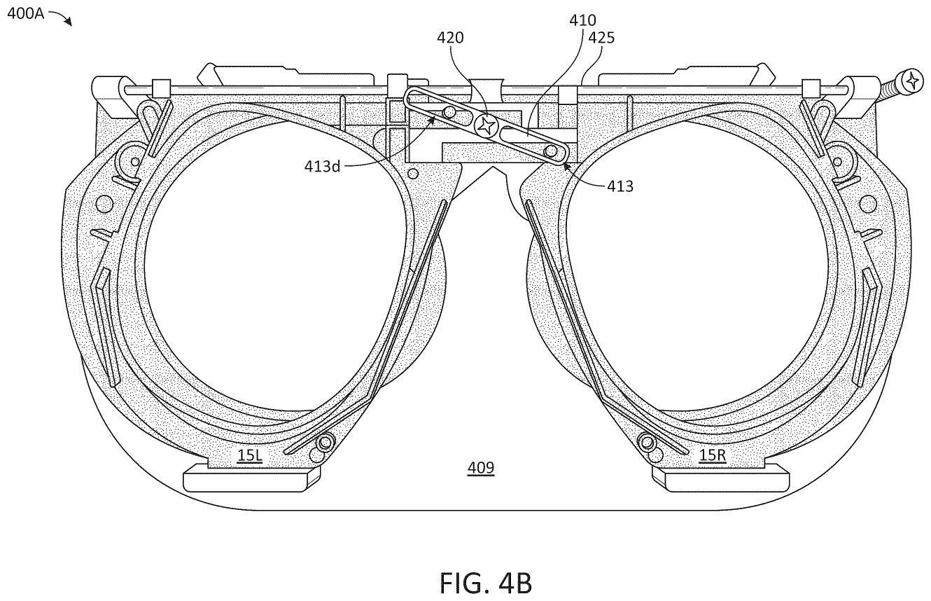

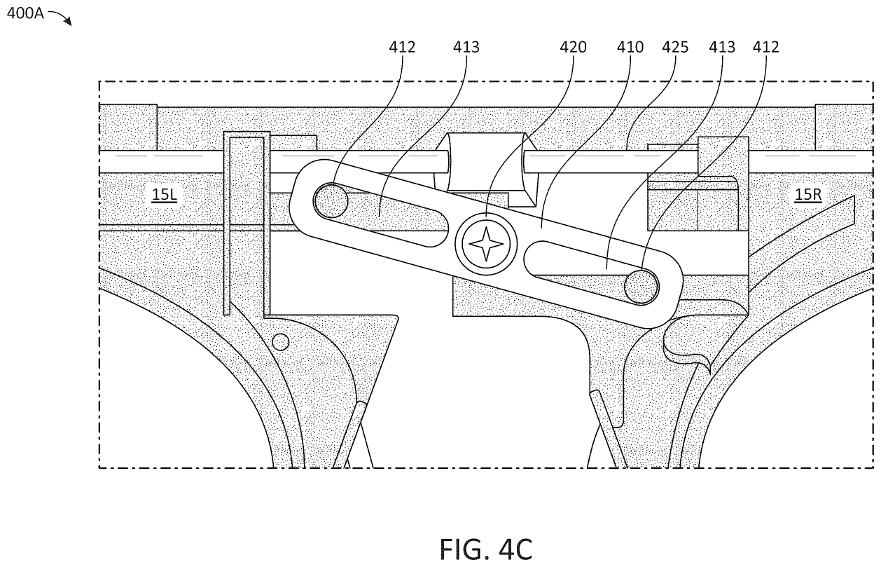

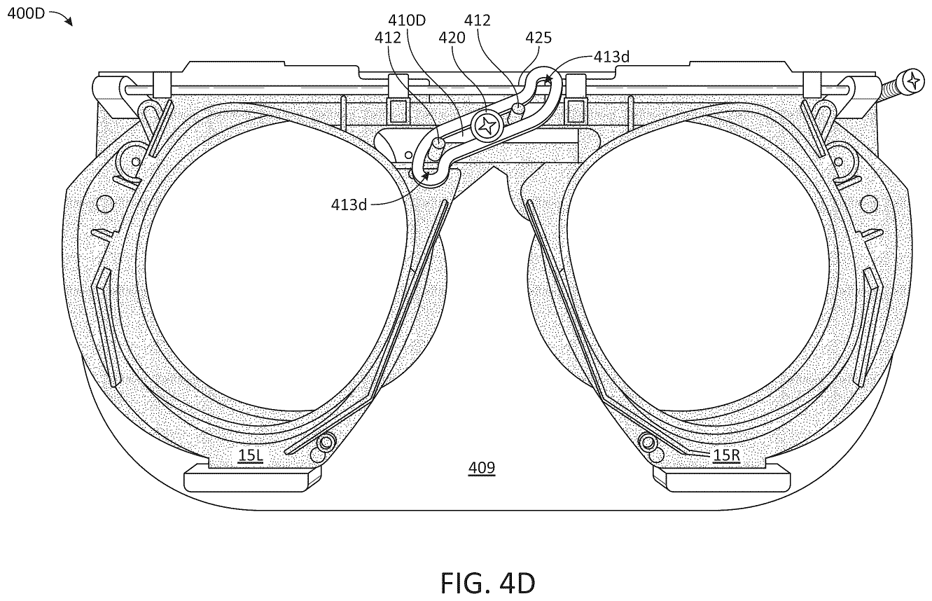

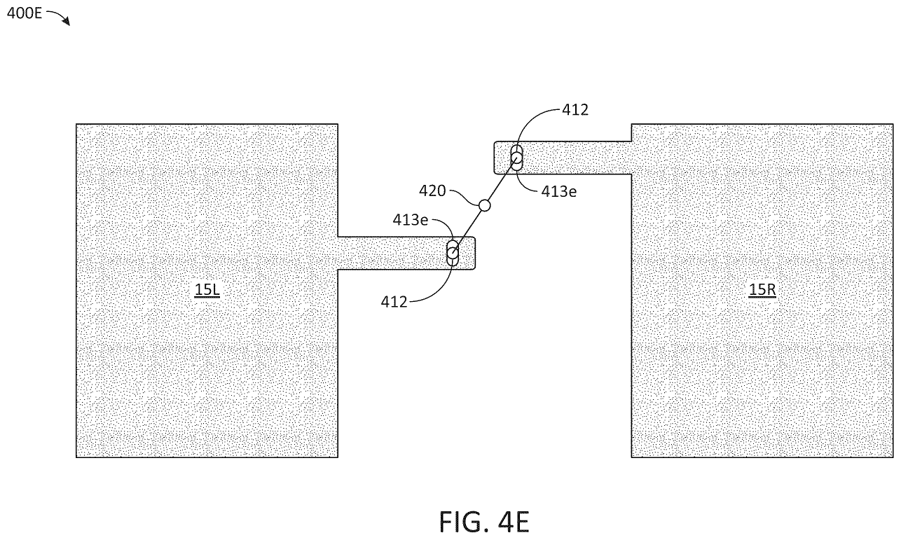

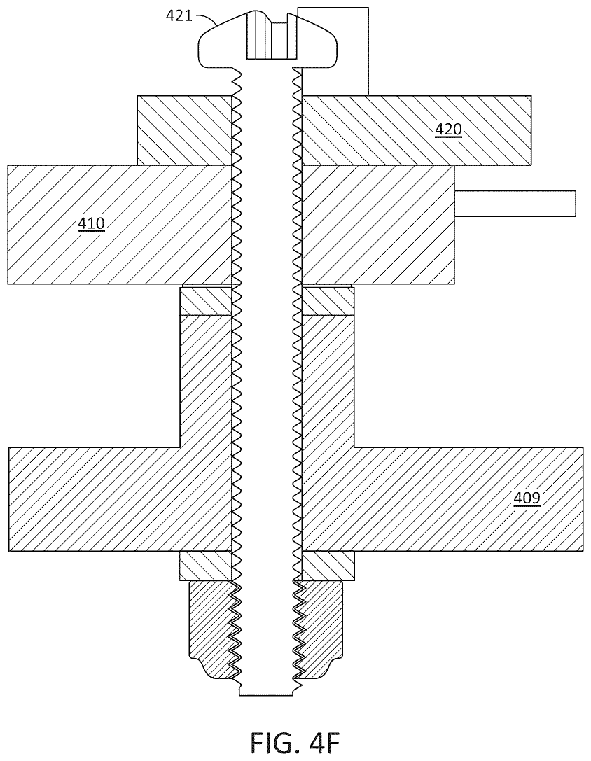

FIGS. 4A-4F illustrate a lever system in mechanisms 400A, 400D, and 400E (hereinafter, collectively referred to as “mechanisms 400”), to adjust IAD in VR/AR headsets, according to some embodiments. A lever 410 rotates about its center by an actuator 420. Actuator 420 may be a screw or a threaded shaft, powered by hand or an electric motor. As lever 410 rotates, it moves pins 412 on slots 413, 413d, and 413e (hereinafter, collectively referred to as “slots 413”) thus displacing eyecups 15L and 15R (hereinafter, collectively referred to as “eyecups 15”) toward or away from each other, relative to a frame 409.

FIG. 4B also illustrates a sliding bar 425 that operates as a rail for the movement of eyecups 15 in mechanism 400A.

FIG. 4C is a close up of lever 410 in mechanism 400A showing more details of pins 412 and slots 413, and the coupling of eyecups 15 to sliding rail 425.

Mechanism 400D includes a lever 410D that has a curved shape (“S” shape) with likewise formed slots 413d. The shape of slots 413d enables the sliding of pins 412 without too much friction, avoiding stoppage, jerking, and slacking of the movement of eyecups 15.

Mechanism 400E includes slots 413e that are formed in extended prongs on each of eyecups 15. This reduces the stress on pins 412 and on lever 410, as it rotates to move cups 15.

FIG. 4F is a detailed cross-sectional view of actuator 420 configured to rotate a screw or threaded shaft 421 that is coupled to lever 410. Threaded shaft 421 is fixed on frame 409, but allowed to rotate about its axis.

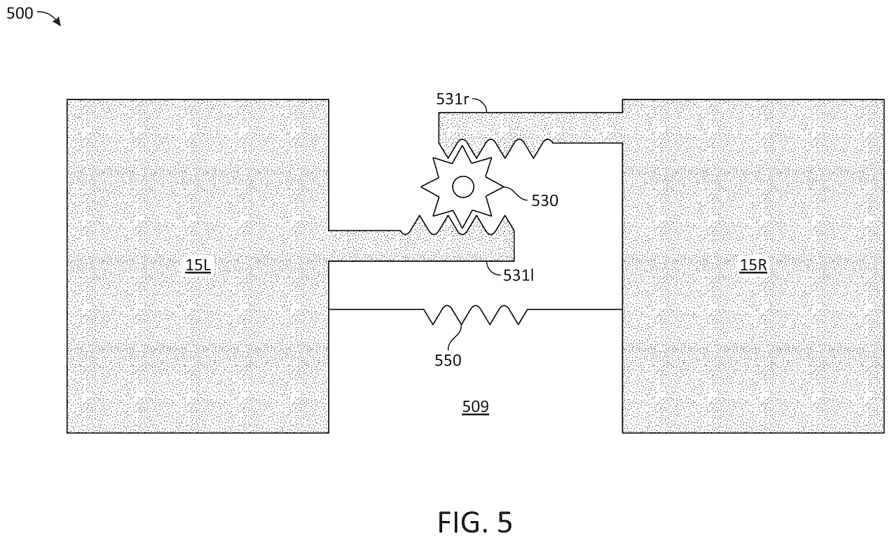

FIG. 5 illustrates a disengaging gear 530 in a mechanism 500 to adjust IAD in VR/AR headsets, according to some embodiments. Gear 530 engages rack prongs 531l and 531r (hereinafter, collectively referred to as “racks 531”) upon rotation about its axis. Accordingly, eyecups 15L and 15R (hereinafter, collectively referred to as “eyecups 15”) move towards or away from one another against frame 509 in the background. A drop event can throw off the phase of gear 530. Accordingly, mechanism 500 allows the user to fix this easily and rapidly.

Gear 530 is configured to be pushed in and out of engagement with racks 531 (e.g., by a spring-loaded mechanism). A spring 550 biases eyecups 15 towards an initial, unperturbed position, to avoid backlash and provide stability and reliability.

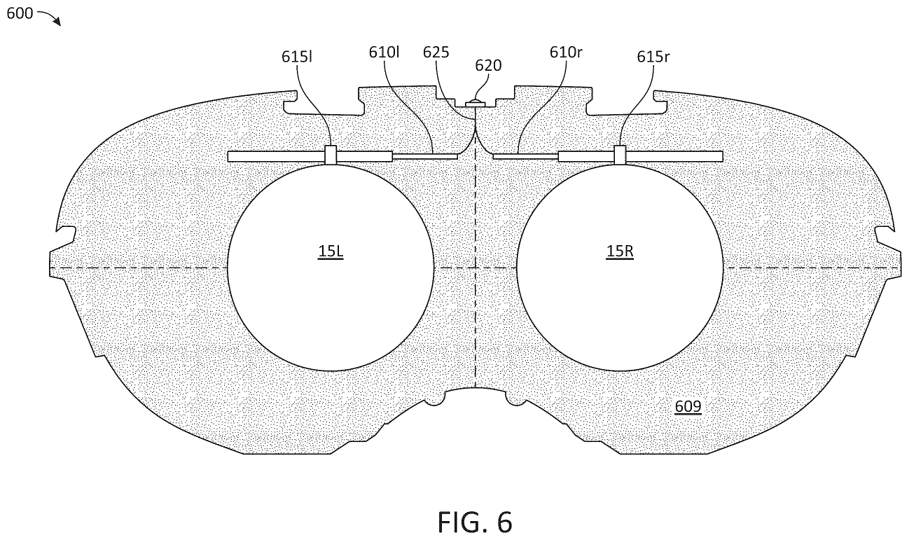

FIG. 6 illustrates a nematic mechanism 600 to adjust IAD in a VR/AR headset, according to some embodiments. An actuator 620 releases a pressurized fluid line 625 that pushes shafts 610l and 610r (hereinafter, collectively referred to as “shafts 610”) in an out, depending on the sign of the gas pressure. Nuts 615l and 615r (hereinafter, collectively referred to as “nuts 615”) are attached to shafts 615 and move eyecups 15L and 15R (hereinafter, collectively referred to as “eyecups 15”) toward or away from one another relative to a frame 609. Pressurized fluid line 625 can include a liquid or a gas.

The pressurized fluid provides support that helps with impulse/crumple-zone in drop tests. However, it may be desirable to ensure a hermetic seal fluid line 625 to avoid release of air, liquid, or other fluids that may damage surrounding electronics/housing, and hinder the thermal behavior of the AR/VR headset. Activation may occur by pressing a button that automatically moves eyecups 15 in one direction. To move in the opposite direction, the user may manually displace at least one eyepiece 15, letting the pressurized line acquire an equilibrium value at the desired configuration.

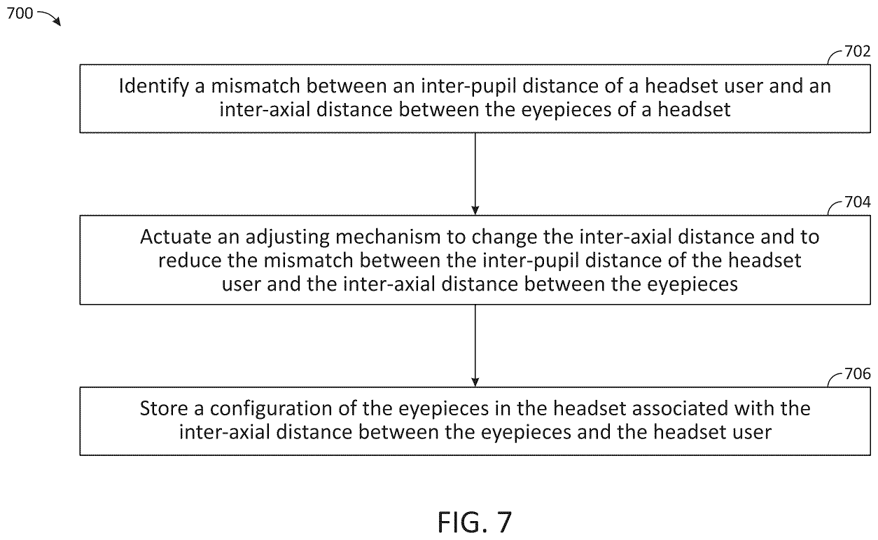

FIG. 7 is a flow chart illustrating steps in a method 700 for adjusting an inter-axial distance between the eyepieces of a VR/AR headset, according to some embodiments. In some embodiments, at least one of the steps in method 700 is performed by a processor executing instructions stored in a memory, to cause a headset, a mobile device, a server or a database, to execute one or more of the steps in method 700 (cf. headset 10, mobile device 11, server 25, and database 27). The headset, mobile device, server, or database may be communicatively coupled via a communications module through a network, as disclosed herein (cf. communications module 18 and network 16). Methods consistent with the present disclosure may include at least one or more steps in method 700 performed in a different order, simultaneously, quasi-simultaneously, or overlapping in time.

Step 702 includes identifying a mismatch between an inter-pupil distance of a headset user and the inter-axial distance between the eyepieces. In some embodiments, step 702 includes determining a position of two pupils, and a gaze direction of the headset user. In some embodiments, step 702 includes determining a displacement of the eyepieces by detecting a rotation of a pinion and rack mechanically coupling two eyecups holding the eyepieces.

Step 704 includes actuating an adjusting mechanism to change the inter-axial distance and to reduce the mismatch between the inter-pupil distance of the headset user and the inter-axial distance between the eyepieces. In some embodiments, the two eyepieces are each held in one of two eyecups, and step 704 includes at least one of: causing a threaded rod rotatably fixed to a frame of the headset and mechanically coupled to the eyecups, to rotate, causing a lever rotatably fixed to the frame of the headset and mechanically coupled to the eyecups, to rotate, causing a vertical fork mechanically coupled to the eyecups, to move vertically, and causing a pressurized fluid line to horizontally push or pull two rods mechanically coupled to the eyecups.

Step 706 includes storing a configuration of the eyepieces in the headset associated with the inter-axial distance between the eyepieces and the headset user.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. §112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A linear actuation mechanism, comprising:
a first threaded rod rotatably fixed on a frame;
an actuator mechanically coupled to the first threaded rod and configured to cause a rotation thereof;
a first nut threaded onto the first threaded rod and attached to a first eyecup configured to hold a first optical element for a headset display; and
a rail on the frame configured to support the first eyecup as it moves with the first nut.

2. The linear actuation mechanism of claim 1, further comprising a second threaded rod rotatably fixed on the frame, and a second nut threaded onto the second threaded rod and attached to a second eyecup configured to hold a second optical element for the headset display, wherein the actuator is mechanically coupled to the second threaded rod and configured to cause a rotation thereof, and the second threaded rod is threaded with a same pitch as the first threaded rod and in an opposite direction.

3. The linear actuation mechanism of claim 1, further comprising a second threaded rod rotatably fixed on the frame, and mechanically coupled with the first threaded rod to rotate in an opposite direction to the first threaded rod upon activation of the actuator, and configured to displace a second eyecup holding a second optical element for a headset display.

4. The linear actuation mechanism of claim 1, further comprising a flat rod fixed on the frame, and a second eyecup configured to hold a second optical element for the headset display, the second eyecup mechanically coupled to the first eyecup via a rack and pinion that causes the second eyecup to move on the flat rod, by a same amount in an opposite direction to the first eyecup when the actuator rotates the first threaded rod.

5. The linear actuation mechanism of claim 1, wherein the first threaded rod is threaded in two opposite directions, further comprising a second nut threaded onto a second portion of the first threaded rod and attached to a second eyecup configured to hold a second optical element for the headset display, wherein the first nut and the second nut are threaded in opposite directions.

6. A headset, comprising:
a frame, supporting:
a display to provide a virtual image generated in an immersive reality application;
two optical elements to provide the virtual image to a headset user; and
a linear actuation mechanism configured to adjust an inter-axial distance between the two optical elements, the linear actuation mechanism comprising:
an actuator coupled to a mechanical element and configured to cause a motion thereof;
a first eyecup configured to support one of the optical elements, the first eyecup coupled to the mechanical element to move in a first direction by a selected distance upon an actuation of the mechanical element; and
a second eyecup configured to support another of the optical elements, the second eyecup coupled to the mechanical element to move in a second direction by the selected distance upon the actuation of the mechanical element, wherein the second direction is opposite to the first direction.

7. The headset of claim 6, wherein the mechanical element comprises a threaded rod rotatably fixed on the frame, and a nut threaded onto the threaded rod and attached to the first eyecup, wherein the actuator is configured to cause a rotation of the threaded rod.

8. The headset of claim 6, wherein:
the mechanical element comprises a first threaded rod and a second threaded rod configured to rotate in opposite directions upon activation of the actuator,
the first eyecup is coupled to the first threaded rod via a first nut, and
the second eyecup is coupled to the second threaded rod via a second nut.

9. The headset of claim 6, wherein the mechanical element includes a threaded rod and a flat rod rotatably fixed on the frame, the first eyecup is coupled to the threaded rod via a nut fixed on the first eyecup, the second eyecup mechanically coupled to the first eyecup via a rack and pinion that causes the second eyecup to move on the flat rod upon activation of the actuator.

10. The headset of claim 6, wherein the mechanical element includes a threaded rod, threaded in two opposite directions, and the first eyecup is coupled to the threaded rod with a first nut threaded in one of the opposite directions and the second eyecup is coupled to the threaded rod in another of the opposite direction.

11. The headset of claim 6, wherein the mechanical element is a threaded rod horizontally disposed on the frame.

12. The headset of claim 6, wherein the mechanical element is a threaded rod perpendicular to a plane of the frame and mechanically coupled to a lever having two slots on either side of the threaded rod, wherein the first eyecup includes a pin that fits in one of the slots, and the second eyecup includes a pin that fits in another of the slots.

13. The headset of claim 6, wherein the mechanical element is a threaded rod perpendicular to a plane of the frame and mechanically coupled to a lever having two slots on either side of the threaded rod, wherein the first eyecup includes a pin that fits in one of the slots, and the second eyecup includes a pin that fits in another of the slots, and wherein the two slots are formed into a spiral curve centered on the threaded rod.

14. The headset of claim 6, wherein the mechanical element includes two slots forming an angled fork in a vertical direction, wherein the first eyecup includes a pin that fits in one of the slots, and the second eyecup includes a pin that fits in another of the slots, and the actuator is configured to move the mechanical element in the vertical direction.

15. The headset of claim 6, further comprising a rail on the frame configured to support the first eyecup and the second eyecup as they move away from or towards one another.

16. The headset of claim 6, wherein the actuator is a pressurized fluid line and the mechanical element includes two rods fluidically coupled at opposite ends of the pressurized fluid line.

17. A method to adjust an inter-axial distance between two eyepieces in a headset, comprising:
identifying a mismatch between an inter-pupil distance of a headset user and the inter-axial distance between the eyepieces;
actuating an adjusting mechanism to change the inter-axial distance and to reduce the mismatch between the inter-pupil distance of the headset user and the inter-axial distance between the eyepieces; and
storing a configuration of the eyepieces in the headset associated with the inter-axial distance between the eyepieces and the headset user.

18. The method of claim 17, wherein identifying a mismatch comprises determining a position of two pupils, and a gaze direction of the headset user.

19. The method of claim 17, wherein identifying a mismatch comprises determining a displacement of the eyepieces by detecting a rotation of a pinion and rack mechanically coupling two eyecups holding the eyepieces.

20. The method of claim 17, wherein the two eyepieces are each held in one of two eyecups, and actuating an adjusting mechanism comprises at least one of:
causing a threaded rod rotatably fixed to a frame of the headset and mechanically coupled to the eyecups, to rotate,
causing a lever rotatably fixed to the frame of the headset and mechanically coupled to the eyecups, to rotate,
causing a vertical fork mechanically coupled to the eyecups, to move vertically, and
causing a pressurized fluid line to horizontally push or pull two rods mechanically coupled to the eyecups.
